(19) United States
(12) Patent Application Publication
(10) Pub. No.: US 2024/0324592 A1
(43) Pub. Date: Oct. 3, 2024

(54) COMPOSITION FOR SANITIZING A SURFACE OF SKIN

(71) Applicant: Kao USA Inc., Cincinnati, OH (US)

(72) Inventors: Prajakta Songade, Mason, OH (US); Adam P. Schrott, Hebron, KY (US)

(21) Appl. No.: 18/129,389

(22) Filed: Mar. 31, 2023

Related U.S. Application Data
(63) Continuation-in-part of application No. 18/127,151, filed on Mar. 28, 2023, now abandoned.

(51) Int. Cl. A01N 33/12; A01N 25/16; A01N 25/30

(52) U.S. Cl. CPC A01N 33/12; A01N 25/16; A01N 25/30

(57) ABSTRACT

The instant disclosure relates to a composition, for sanitizing a surface of skin, including benzalkonium chloride for disrupting a microbial cell in contact with the surface of skin, in an amount ranging from 0.05% to less than 1% by weight of the composition. The composition may also include a silicone surfactant in an amount ranging from 0.01% to 2% by weight of the composition, as well as an additional cationic surfactant.

### FIELD OF TECHNOLOGY

Disclosed are compositions for sanitizing a surface of skin, as well as methods of making and using same.

### BACKGROUND

Sanitizers are commonly used to disinfect surfaces and human skin. In particular, hand sanitizers are used for disinfecting one's hands after using a restroom or touching surfaces that are exposed to the public. Hand sanitizers typically contain a high content of alcohol, for example, 60% or more by weight, for disinfecting.

A subset of hand sanitizers includes foaming hand sanitizers, which are usually released from a dispenser, then rubbed onto one's hands. Such hand sanitizers may be leave-on or subsequently washed off, for instance, with water.

A need exists for a foaming hand sanitizer that has improved foam features, including one or more of consistency, quality, texture, and smaller bubble size. Furthermore, a need exists for a hand sanitizer that is free, or substantially free, of alcohol, to reduce and/or prevent drying of the skin after use. The instant disclosure addresses one or more of the aforementioned needs in the art.

### SUMMARY

Disclosed are compositions for sanitizing the surface of skin. The disclosed compositions may include benzalkonium chloride, for disrupting a microbial cell in contact with the surface of skin, in an amount ranging from 0.05% to less than 1% by weight of the composition. The disclosed compositions may also include a silicone surfactant in an amount ranging from 0.01% to 2% by weight of the composition. The disclosed compositions may also include an additional cationic surfactant.

The disclosed compositions may be used to sanitize a surface of skin (for instance, a user's hands) without the use of alcohol (ethanol). The disclosed compositions may also provide an improved user experience via better foam consistency and may be left on the surface of skin after use (i.e., no rinsing is required). Furthermore, the disclosed compositions may be used without a drying of the surface of skin occurring after use.

### DETAILED DESCRIPTION

A composition for sanitizing a surface of skin is presented. In certain aspects, the composition may include a solvent, benzalkonium chloride, and at least one surfactant.

### Solvent

In one aspect, the composition may include a solvent for subsuming the remaining ingredients of the composition. The solvent may be present in an amount necessary to total a weight of the composition to 100% (QS). For instance, the solvent may be present in an amount ranging from 45% to 95%, or from 50% to 90%, or from 55% to 85%, or from 60% to 80%, or from 65% to 75% by weight of the composition. The solvent may be present in an amount of from at least 45%, or 50%, or 55%, or 60%, or 65% to 75%, or 80%, or 85%, or 90%, or 95% by weight of the composition. In one aspect, the solvent is water, and may be deionized water.

### Benzalkonium Chloride

The composition may include the cationic surfactant benzalkonium chloride as an antimicrobial agent. Without intending to be bound by theory, it is believed that benzalkonium chloride disrupts microbial cells in contact with the surface of skin. The composition may comprise benzalkonium chloride in an amount of from 0.05% to less than 1% by weight of the composition. For instance, the amount may range from 0.05%, or 0.06%, or 0.075%, or 0.1%, or 0.15%, or 0.2%, or 0.25% to 0.3%, or 0.4%, or 0.5%, or 0.6%, or 0.7%, or 0.8%, or 0.9% by weight of the composition. In one aspect, benzalkonium chloride may be present as a 50% antimicrobial active in a carrier (for instance, the carrier may be water).

### Silicone Surfactant

The composition may include a silicone surfactant. The silicone surfactant may be present in an amount ranging from 0.01% to 2% by weight of the composition. The amount may range from 0.01%, or 0.05%, or 0.1%, or 0.2%, or 0.3%, or 0.4%, or 0.5% to 0.6%, or 0.7%, or 0.8%, or 0.9%, or 1%, or 1.5%, or 2% by weight of the composition. In one aspect, the silicone surfactant may be a linear dimethicone. Non-limiting examples of a linear dimethicone that may be used in the disclosed compositions include PEG-10 dimethicone, PEG-12 dimethicone, bis PEG-12 dimethicone, PEG-17 dimethicone, and combinations thereof.

### Additional Cationic Surfactant

The composition may include an additional cationic surfactant, i.e., in addition to benzalkonium chloride. The additional cationic surfactant may be present in an amount ranging from 0.1% to 4% by weight of the composition. The amount may range from 0.1%, or 0.2%, or 0.3%, or 0.4%, or 0.5%, or 0.6%, or 0.7%, 0.8%, or 0.9%, or 1%, or 1.1%, or 1.25%, or 1.3%, or 1.4%, or 1.5%, or 1.75%, or 1.8%, or 2% to 2.1%, or 2.25%, or 2.3%, or 2.4%, or 2.5%, or 2.75%, or 2.8%, or 2.9%, or 3%, or 3.1%, or 3.2%, or 3.4%, or 3.5%, or 3.6%, or 3.7%, or 3.8%, or 3.9%, or 4% by weight of the composition. Non-limiting examples of the additional cationic surfactant may include quaternary ammonium compounds, such as behentrimonium chloride and cetrimonium chloride.

### Non-Ionic Surfactants

The composition may further include at least one non-ionic surfactant, for boosting and stabilizing foam formation of the composition. Non-limiting examples of the at least one non-ionic surfactant are as follows:

A poloxamer (i.e., a hydrophilic non-ionic block copolymer surfactant having ethylene oxide and propylene oxide blocks) may be included in an amount ranging from 0.01% to 2% by weight of the composition. The amount may range from 0.01%, or 0.05%, or 0.1%, or 0.2%, or 0.3%, or 0.4%, or 0.5% to 0.6%, or 0.7%, or 0.8%, or 0.9%, or 1%, or 1.5%, or 2% by weight of the composition. Non-limiting examples of the poloxamer may include poloxamer 188 (e.g., Kolliphor® P 188, Pluronic® F-68, Synperonic™ PE/F 68, and Lutrol® F68) and poloxamer 407 (e.g., Pluronic® F-127, Synperonic™ PE/F 127, and Kolliphor® P 407), and combinations thereof.

A non-ionic polyoxyethylene ether may be included in an amount ranging from 0.01% to 2% by weight of the composition. The amount may range from 0.01%, or 0.05%, or 0.1%, or 0.2%, or 0.3%, or 0.4%, or 0.5% to 0.6%, or 0.7%, or 0.8%, or 0.9%, or 1%, or 1.5%, or 2% by weight of the composition. Non-limiting examples of the non-ionic polyoxyethylene ether may include ceteareth-2, ceteareth-3, ceteareth-4, ceteareth-5, ceteareth-6, ceteareth-7, ceteareth-8, ceteareth-9, ceteareth-10, ceteareth-11, ceteareth-12, ceteareth-13, ceteareth-14, ceteareth-15, ceteareth-16, ceteareth-17, ceteareth-18, ceteareth-20, ceteareth-22, ceteareth-23, ceteareth-24, ceteareth-25, ceteareth-27, ceteareth-28, ceteareth-29, ceteareth-30, ceteareth-33, ceteareth-34, ceteareth-40, and combinations thereof.

### Other Ingredients

The composition may also include other ingredients in addition to the above. Such ingredients may have functions such as (but not limited to): further boosting and stabilizing foam formation of the composition, decreasing viscosity of the composition, supplemental solvents, supplemental surfactants, hydrophobic solvents, solubilizers, and fragrances.

In one version, the composition may include a polyol. The polyol may be present in an amount ranging from 1% to 6% by weight of the composition. The amount may range from 1%, or 1.5%, or 2%, or 2.5%, or 3%, to 4%, or 4.5%, or 5%, or 5.5%, or 6% by weight of the composition. Non-limiting examples of polyols include butylene glycol, glycerin, propanediol, propylene glycol, and combinations thereof.

In one version, the composition may include a glycol ether. The glycol ether may be present in an amount ranging from 0.1% to 4% by weight of the composition. The amount may range from 0.1%, or 0.2%, or 0.5%, or 1%, or 1.5%, to 2%, or 2.5%, or 3%, or 3.5%, or 4% by weight of the composition. Non-limiting examples of the glycol ether include butylene glycol, dipropylene glycol, ethoxydiglycol, hexylene glycol, propylene glycol, and combinations thereof.

In one version, the composition may include an alkyl glyceryl ether. The alkyl glyceryl ether may be present in an amount ranging from 0.01% to 2% by weight of the composition. The amount may range from 0.01%, or 0.02%, or 0.05%, or 0.07%, or 0.08%, to 0.1%, or 0.5%, or 1%, or 1.5%, or 2% by weight of the composition. Non-limiting examples of alkyl glyceryl ether include ethylhexylglycerin, methylheptylglycerin, and combinations thereof.

In one version, the composition may include a solubilizer. The solubilizer may be added to allow hydrophobic ingredients to be soluble within the composition. The solubilizer may be present in an amount ranging from 0.01% to 2% by weight of the composition. The amount may range from 0.01%, or 0.02%, or 0.05%, or 0.07%, or 0.08%, to 0.1%, or 0.5%, or 1%, or 1.5%, or 2% by weight of the composition. The solubilizer may be a polyethylene glycol derivative of hydrogenated castor oil. Non-limiting examples of the solubilizer include PEG-7 glyceryl cocoate, PEG-40 hydrogenated castor oil, polysorbate 20, polysorbate 80, and combinations thereof.

In one version, the composition may include a fragrance for providing an aesthetically pleasing scent to the composition. The fragrance may be present in an amount ranging from 0.01% to 0.5% by weight of the composition.

The composition may include combinations of the above ingredients.

### Excluded Ingredients

In one aspect, the composition may contain less than 0.1%, or 0.05%, or 0.01% ethanol. In one aspect, the composition may be free of (contains 0%), or substantially free of ethanol. The term “substantially free of” as used herein refers to either the complete absence (0% by weight of the composition) of an ingredient, or a minimal amount thereof merely as impurity or unintended byproduct of another ingredient. In some aspects, a composition that is “substantially free” of a component means that the composition comprises less than 0.1%, or less than 0.05%, or less than 0.01%, or even 0%, by weight of the composition, of the component. It is understood that the disclosed compositions do not include intentionally-added ethanol as an ingredient.

### Example Compositions

The following are non-limiting examples of the composition as disclosed herein:
Example 1: water (QS), linear dimethicone (0.1%), quaternary ammonium compound (2%), benzalkonium chloride (0.13%).
Example 2: water (QS), linear dimethicone (1.5%), quaternary ammonium compound (0.6%), benzalkonium chloride (0.13%).
Example 3: water (QS), poloxamer (0.1%), alkyl glyceryl ether (0.02%), solubilizer (1%), linear dimethicone (0.3%), quaternary ammonium compound (1.5%), benzalkonium chloride (0.13%).
Example 4: water (QS), poloxamer (1.8%), alkyl glyceryl ether (0.8%), solubilizer (0.5%), linear dimethicone (0.75%), quaternary ammonium compound (0.2%), benzalkonium chloride (0.13%).
Example 5: water (QS), poloxamer (0.5%), alkyl glyceryl ether (1.5%), linear dimethicone (1%), quaternary ammonium compound (1.5%), benzalkonium chloride (0.13%).
Example 6: water (QS), poloxamer (0.05%), solubilizer (0.08%), linear dimethicone (1.7%), quaternary ammonium compound (0.5%), benzalkonium chloride (0.13%).
Example 7: water (QS), non-ionic polyoxyethylene ether (1.5%), alkyl glyceryl ether (0.1%), linear dimethicone (0.1%), quaternary ammonium compound (0.5%), benzalkonium chloride (0.13%).
Example 8: water (QS), non-ionic polyoxyethylene ether (0.1%), solubilizer (1.7%), linear dimethicone (0.8%), quaternary ammonium compound (1.75%), benzalkonium chloride (0.13%).
Example 9: water (QS), poloxamer (0.75%), non-ionic polyoxyethylene ether (0.5%), alkyl glyceryl ether (1.6%), solubilizer (0.1%), linear dimethicone (1.3%), quaternary ammonium compound (1.2%), benzalkonium chloride (0.13%).
Example 10: water (QS), poloxamer (1.4%), non-ionic polyoxyethylene ether (0.3%), alkyl glyceryl ether (0.4%), solubilizer (0.1%), linear dimethicone (0.05%), quaternary ammonium compound (0.8%), benzalkonium chloride (0.13%).
Example 11: water (QS), poloxamer (0.7%), non-ionic polyoxyethylene ether (0.6%), polyol (2.5%), alkyl glyceryl ether (1.8%), solubilizer (1.1%), linear dimethicone (0.1%), quaternary ammonium compound (1.6%), benzalkonium chloride (0.13%).
Example 12: water (QS), poloxamer (1.2%), non-ionic polyoxyethylene ether (1.8%), glycol ether (0.75%), alkyl glyceryl ether (0.6%), solubilizer (0.02%), linear dimethicone (1.5%), quaternary ammonium compound (0.3%), benzalkonium chloride (0.13%).
Example 13: water (QS), poloxamer (0.07%), non-ionic polyoxyethylene ether (1.3%), polyol (4.5%), glycol ether (3.5%), alkyl glyceryl ether (1.3%), solubilizer (1.5%), linear dimethicone (0.8%), quaternary ammonium compound (1.5%), benzalkonium chloride (0.13%).

### Dynamic Foam Analysis

Dynamic Foam analysis (DFA) was performed on four test formulations (TF), see Table 1 below (ingredient amounts listed as percent by weight).

DFA was performed using a KRÜSS Dynamic Foam Analyzer—DFA100 with the ADVANCE software for the Dynamic Foam Analyzer—DFA100. Foam Measurement Method of the software was used (Scientific Foam Analysis), with parameters determined for each sample. A gas flow method was utilized, with an internal air source to pump air into a foaming cylinder at a fixed rate. Air flow disrupts a liquid sample in the foaming cylinder to create foam, which the instrument and software then analyze.

TABLE 1
Test Formulations

| Ingredient | TF1 | TF2 | TF3 | TF4 |
|---|---|---|---|---|
| Water | QS to 100 | QS to 100 | QS to 100 | QS to 100 |
| Poloxamer | 0 | 0.01-2 | 0.01-2 | 0.01-2 |
| Non-ionic | 0 | 0 | 0.01-2 | 0.01-2 |
| Polyoxyethylene | | | | |
| Ether | | | | |
| Glycol Ether | 0 | 0 | 0 | 0.1-4 |
| Alkyl Glyceryl | 0 | 0.01-2 | 0.01-2 | 0.01-2 |
| Ether | | | | |
| Solubilizer | 0 | 0.01-2 | 0.01-2 | 0.01-2 |
| Linear | 0.01-2 | 0.01-2 | 0.01-2 | 0.01-2 |
| Dimethicone | | | | |
| Aliphatic Diol | 0 | 0 | 0 | 1-6 |
| (Polyol) | | | | |
| Quaternary | 0.1-4 | 0.1-4 | 0.1-4 | 0.1-4 |
| Ammonium | | | | |
| Compound | | | | |
| Benzalkonium | 0.05 to | 0.05 to | 0.05 to | 0.05 to |
| Chloride | less than 1 | less than 1 | less than 1 | less than 1 |

It was found that the above test formulations within the ranges set forth above have acceptable DFA performance.

Percent ranges and point values of amounts shown herein are understood to have a+/−1% tolerance.

### Mesh Combinations for Foaming

Table 2 indicates exemplary combinations of top mesh and bottom (lower) mesh sizes that can be used to foam the composition. In one aspect, a composition as disclosed herein may be provided in a container having a top mesh and a bottom mesh combination as provided below.

TABLE 2
Mesh Combinations for Foaming
Mesh Combinations for Foaming

| TOP | BOTTOM |
|---|---|
| MESH | (LOWER) MESH |
| 80 | 70 |
| 100 | 60 |
| 100 | 80 |
| 100 | 100 |
| 150 | 100 |
| 150 | 150 |
| 200 | 100 |
| 200 | 200 |
| 250 | 100 |
| 250 | 150 |
| 250 | 250 |
| 255 | 150 |
| 300 | 100 |
| 300 | 150 |
| 300 | 200 |
| 300 | 300 |
| 330 | 330 |
| 350 | 100 |
| 350 | 150 |
| 350 | 200 |
| 350 | 350 |
| 380 | 150 |

### Air to Liquid Ratios

Air to liquid ratio refers to a volume of an air tank to a volume of a liquid chamber in a pump. The following are non-limiting examples of ratios between air to liquid (air: liquid) that can be used to foam the composition: 7:1, 7.73:1, 9:1, 11:1, 11.19:1, 12:1, 12.59:1, 13:1, 15:1, and 20:1. In one aspect, the composition may be provided in a container having an air to liquid ratio as disclosed above.

### Method of Making

The following is an exemplary, non-limiting method of making the composition:

When hydrophilic and water-soluble ingredients are to be used, these can be incorporated by premixing with deionized water (solvent) at room temperature with stirring to form a hydrophilic solvent mixture. Separately, all the hydrophobic ingredients are premixed together with solubilizers to form a hydrophobic mixture.

Surface active agents (surfactants) and the hydrophobic mixture can then be added to the hydrophilic solvent mixture and mixed until completely incorporated before adding remaining ingredients (e.g., fragrance) according to the composition.

### Method of Use

The following are general, non-limiting methods of use of the composition as disclosed herein.

In one aspect, a method of sanitizing a surface (for instance, a surface of skin) is disclosed. In one aspect, the method may include contacting a composition as disclosed herein with the surface. A composition as disclosed herein may be dispensed from a container having a pump. In one aspect, the pump may include a mesh for foaming the composition.

In another aspect, 0.1 g to 2 g of a composition as disclosed herein is dispensed from a container having a pump including a mesh, onto a hand of a user. The container may be free-standing or attached to a wall. The composition may be dispensed upward, outward, or downward onto the hand of the user. The user then rubs the composition into the hand (or a pair of hands) until the composition is no longer visible. Alternatively, the user may rub the composition onto any surface of skin (e.g., arms and legs).

The methods may further comprise administering a composition as disclosed herein, wherein the composition is foamed prior to contact with the surface of skin. In one aspect, the foaming is carried out using a container having a top mesh and a bottom mesh combination and/or an air to liquid combination as provided herein.

All percentages and ratios are calculated by weight unless otherwise indicated.

All percentages and ratios are calculated based on the total weight of the composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Percent ranges of amounts, and other numerical values, as disclosed herein, are understood to include the recited value+/−1% unless otherwise specified.

As used herein, articles such as “a” and “an” when used in a claim, are understood to mean one or more of what is claimed or described.

As used herein, the terms “comprising,” “comprises,” “include”, “includes” and “including” are meant to be non-limiting. The term “consisting of” or “consisting essentially of” are meant to be limiting, i.e., excluding any components or ingredients that are not specifically listed except when they are present as impurities.

All references, including patent applications, patent publications, and non-patent literature, that are referred to in the present specification are incorporated by reference herein, unless it is expressly indicated that they are not incorporated by reference herein.

Having shown and described various aspects of the present invention, further adaptations of the compositions and methods described herein may be accomplished by appropriate modifications by one of ordinary skill in the art without departing from the scope of the present invention. Several of such potential modifications have been mentioned, and others will be apparent to those skilled in the art. For instance, the examples, materials, ratios, steps, and the like discussed above are illustrative and are not required. Accordingly, the scope of the present invention should be considered in terms of any claims that may be presented and is understood not to be limited to the details of composition and operation described in the specification.

What is claimed is:

1. A composition, for sanitizing a surface of skin, comprising:
a solvent;
from 0.05% to less than 1% of benzalkonium chloride by weight of said composition;
from 0.01% to 2% of a silicone surfactant by weight of said composition; and
an additional cationic surfactant.

2. Said composition of claim 1, wherein said silicone surfactant is a linear dimethicone.

3. Said composition of claim 2, wherein said linear dimethicone is selected from PEG-10 dimethicone, PEG-12 dimethicone, bis PEG-12 dimethicone, PEG-17 dimethicone, and combinations thereof.

4. Said composition of claim 1, wherein said additional cationic surfactant is selected from behentrimonium chloride and cetrimonium chloride.

5. Said composition of claim 1, further comprising at least one non-ionic surfactant.

6. Said composition of claim 5, wherein said at least one non-ionic surfactant comprises a poloxamer and a non-ionic polyoxyethylene ether.

7. Said composition of claim 6, wherein said poloxamer is selected from poloxamer 188, poloxamer 407, and combinations thereof.

8. A composition, for sanitizing a surface of skin, said composition comprising:
a solvent;
from 0.05% to less than 1% of benzalkonium chloride by weight of said composition;
from 0.01% to 2% of a linear dimethicone by weight of said composition; and
an additional cationic surfactant.

9. Said composition of claim 8, wherein said linear dimethicone is selected from PEG-10 dimethicone, PEG-12 dimethicone, bis PEG-12 dimethicone, PEG-17 dimethicone, and combinations thereof.

10. Said composition of claim 8, wherein said additional cationic surfactant is selected from behentrimonium chloride and cetrimonium chloride.

11. Said composition of claim 10, wherein said additional cationic surfactant is present at an amount of from 0.1% to 4% by weight of said composition.

12. Said composition of claim 8, wherein said composition comprises at least one non-ionic surfactant.

13. Said composition of claim 12, wherein said at least one non-ionic surfactant comprises a poloxamer and a non-ionic polyoxyethylene ether.

14. Said composition of claim 13, wherein said poloxamer is selected from poloxamer 188, poloxamer 407, and combinations thereof.

15. A composition, for sanitizing a surface of skin, comprising:
a solvent;
from 0.05% to less than 1% of benzalkonium chloride by weight of said composition;
from 0.01% to 2% of bis PEG-12 dimethicone by weight of said composition; and
an additional cationic surfactant.

16. Said composition of claim 15, wherein said additional cationic surfactant is selected from behentrimonium chloride and cetrimonium chloride.

17. Said composition of claim 16, wherein said additional cationic surfactant is present at an amount of from 0.1% to 4% by weight of said composition.

18. Said composition of claim 15, further comprising at least one non-ionic surfactant.

19. Said composition of claim 18, wherein said at least one non-ionic surfactant comprises a poloxamer and a non-ionic polyoxyethylene ether.

20. Said composition of claim 19, wherein said poloxamer is selected from poloxamer 188, poloxamer 407, and combinations thereof.
